(19) United States
(12) Patent Application Publication
(10) Pub. No.: US 2017/0221347 A1
(43) Pub. Date: Aug. 3, 2017

(54) PORTABLE ALARM SYSTEM

(71) Applicant: Hippi, LLC, Clermont, FL (US)

(72) Inventors: Brian K. Hess, Clermont, FL (US); Frank B. Clark, Longview, TX (US)

(21) Appl. No.: 15/492,675

(22) Filed: Apr. 20, 2017

Related U.S. Application Data
(63) Continuation of application No. 14/711,297, filed on May 13, 2015, now abandoned.
(60) Provisional application No. 61/992,606, filed on May 13, 2014.

(51) Int. Cl. G08B 25/01; G08B 25/10

(52) U.S. Cl. CPC G08B 25/016; G08B 25/10; H04B 2001/3894

(57) ABSTRACT

A portable alarm system is disclosed. The portable alarm system includes a portable base station, which has an outer housing that encloses a power supply and a watertight secondary protective housing. The secondary protective housing encloses a controller and a cellular modem that are electrically connected to each other. A super capacitor is configured to maintain a store of energy and that is electrically connected to the controller and the cellular modem to provide power thereto is also enclosed in the watertight secondary protective housing.

### CROSS-REFERENCE TO RELATED APPLICATIONS

This application is a continuation application that claims the benefit of U.S. application Ser. No. 14/711,297 filed May 13, 2015 which claims priority to U.S. Application No. 61/992,606, filed on May 13, 2014. The entire disclosures of the above applications are incorporated herein by reference.

### FIELD

The present disclosure relates to portable alarm systems.

### BACKGROUND

Portable alarm systems are now known in the marketplace. Exemplary portable alarm systems are manufactured and sold by Tattletale Portable Alarm Systems, Inc. of Columbus, Ohio. The following United States patents describe representative portable alarm systems: U.S. Pat. No. 5,587,701; U.S. Pat. No. 6,049,273; U.S. Pat. No. 6,831,557; U.S. Pat. No. 5,777,551; and U.S. Pat. No. 7,327,220, all of which are incorporated herein by reference. Generally, these portable alarm systems include a portable base station and at least one remote sensor, which is configured to communicate wirelessly with the portable base station. The sensor may be conventional wireless window/door sensors, motion sensors, glass breakage sensors and the like. The base station includes a microprocessor, a receiver configured to receiver wireless signals from the wireless sensor 14 and a wireless transceiver configured to communicate over known wireless networks, such as 3G and 4G LTE networks. The portable base station may also include an integrated motion sensor and a rechargeable battery. In operation, when the sensor detects a trigger event (e.g., window opening, door opening, glass breakage, motion), the wireless sensor emits a wireless signal, which is received by receiver in the base station. The receiver converts the wireless signal to an electrical signal, which is communicated to the microprocessor. The microprocessor may cause the transceiver to initiate a wireless call to a remote location, e.g., a monitoring station or a designated telephone number, or to initiate other types of communications, such as a text message or alert to a smart phone or other portable electronic device.

The inventors hereof have developed improvements to the functionality and usefulness of this existing portable alarm system.

### DRAWINGS

The drawings described herein are for illustrative purposes only of selected embodiments and not all possible implementations, and are not intended to limit the scope of the present disclosure.

FIG. 1 is a perspective view of a portable alarm base station according to an embodiment of the invention, including illustrations of select internal componentry.

FIG. 2 is a functional diagram of the internal componentry of the exemplary portable alarm base station illustrated in FIG. 1.

FIG. 3 is an environmental diagram illustrating communications between the portable alarm base station shown in FIGS. 1 and 2 and various external devices.

Corresponding reference numerals indicate corresponding parts throughout the several views of the drawings.

### DETAILED DESCRIPTION

Example embodiments will now be described more fully with reference to the accompanying drawings.

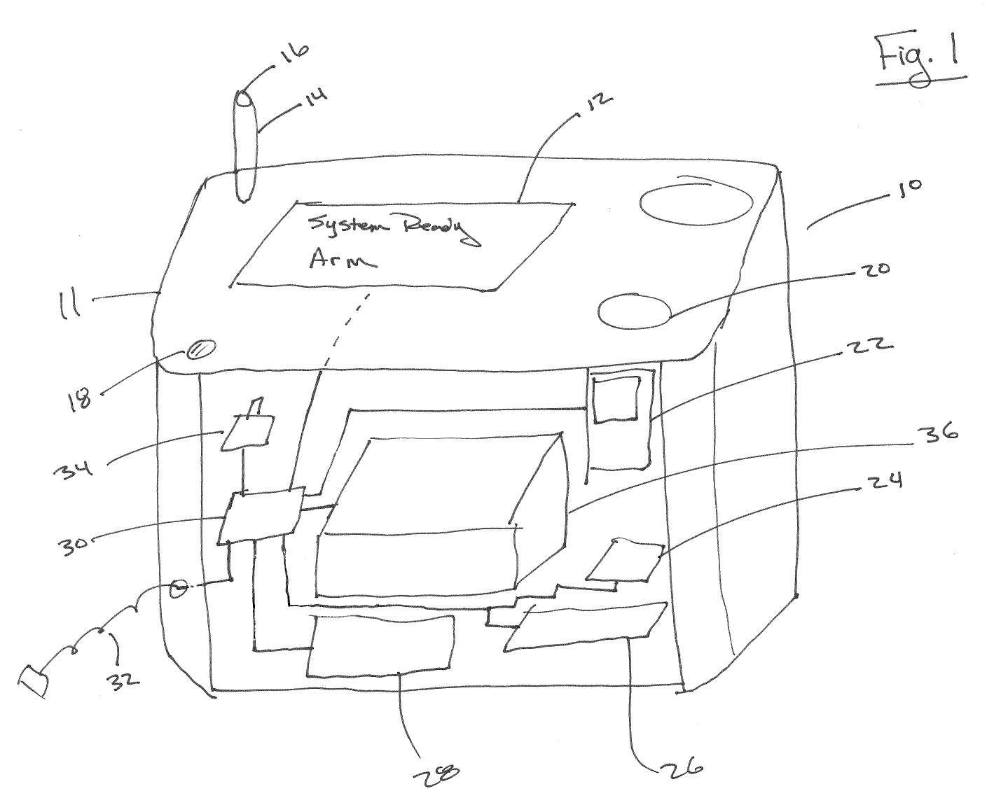

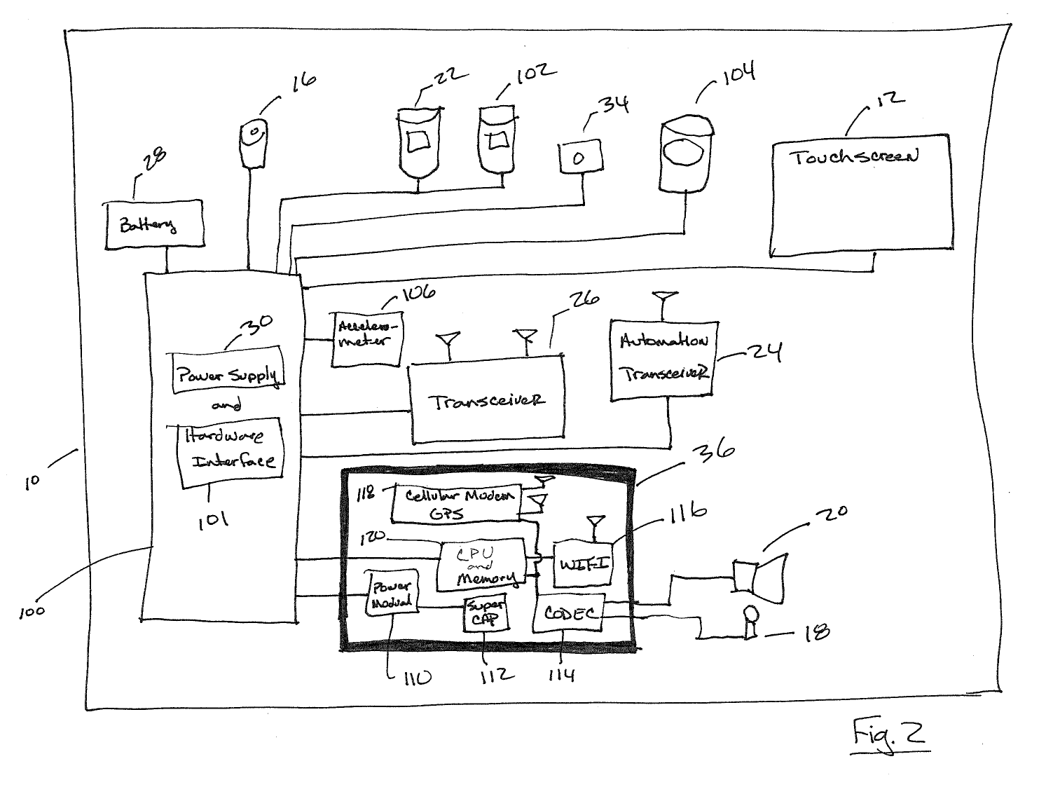

FIG. 1 illustrates a portable alarm base station 10. The portable alarm base station 10 includes a housing 11 that encloses various internal components for operating the portable alarm system. The base station 10 includes a touch screen display 12, a rotatable camera 16 that may be mounted to an antenna 14, a microphone 18 and a speaker 20, all of which are disposed on an outer surface of the housing 11. The following components are incorporated inside of housing 11: a power supply 30, a front motion sensor 22, an 8-wave or other automation transceiver 24, a two-way wireless transceiver 26, a backup battery 28, and a pressure sensor 34. The housing also encloses therein a secondary protective housing 36, which includes therein several critical operational components (shown in FIG. 2). The system further includes a power cord 32 that extends external to the housing 11 to plug into a standard wall power outlet. The power supply 30 distributes power to all of the components of the base station 10 that requires power. The power supply 30 draws power from the battery 28 or, if the base station 10 is plugged into a standard wall outlet, through power cord 32. The base station 10 may also include a rear motion sensor (not shown in FIG. 1).

FIG. 2 is a functional diagram of the internal components of the base station 10 shown in FIG. 1, wherein common elements have common reference numerals. Base station 10 includes a power supply and hardware interface module 100, which includes the power supply 30 and a hardware interface 101. The power supply and hardware interface module 100 supplies power and provides a hardware interface to the various components housed in the base station 10. The power supply and hardware interface module 100 receives power from battery 28 and/or from a standard wall outlet. Power supply and hardware interface module 100 is electrically connected to rotatable camera 16, front and rear motion sensors 22 and 102, pressure sensor 34, strobe light 104, and touchscreen display 12. The power supply and hardware interface module 100 is further electrically connected to accelerometer 106, two-way transceiver 26 and automation transceiver 24. FIG. 2 further illustrates secondary protective housing 36, having housed therein the following components: a cellular modem and GPS unit 118, a WIFI transceiver 116 a power module 110, a super capacity 112, CODEC 114, and a CPU and memory 120. Power supply and hardware interface module 100 is electrically connected to the power module 110 and the CPU/Memory 120 inside of the secondary protective housing 36. The CPU/memory 120 is electrically connected to the WIFI transceiver 116, the CODEC 114 and the cellular modem/GPS module 118.

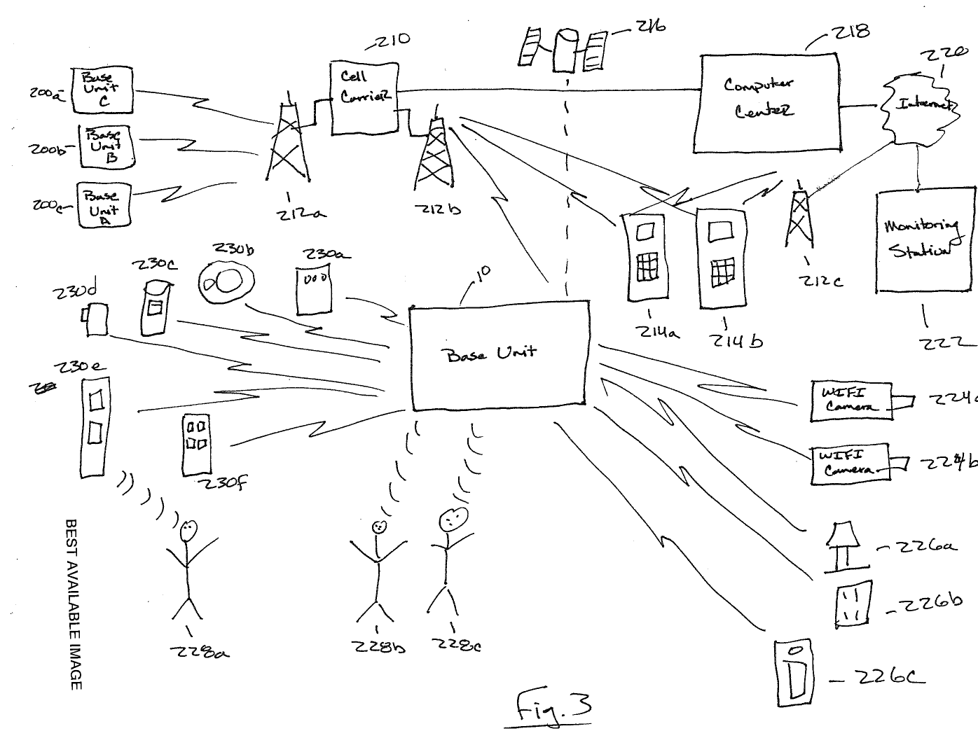

FIG. 3 is an environmental illustration showing various communication paths of the base station 10. The base station 10 receives inputs from users 228a-c. The inputs can be tactile using the touchscreen display 12 or verbal. The users 228a-228c may also receive auditory alerts from the base station 10. The base station 10 further communicates with a variety of wireless sensors 230a-230d and key fobs and remote controls 230e-230f. The wireless sensors 230a-230d provide alarm signals to base station 10 and key fobs and remote controls 230e-230f provide wireless control signals to base station 10. Base stations 200a-200c communicate wirelessly with cell tower 212a, which is communicatively coupled to cell carrier 210. Cell tower 212b is also communicatively coupled to cell carrier 210 and wirelessly communicates with cell phone devices 214a and 214b. Cell phone devices 214a and 214b can wirelessly communicate with monitoring station 222 and computer center 218 via cell tower 212c and internet 220. Base station 10 communicates directly with cell phones 214a and 214b via cell tower 212b. Base station 10 also communicates with computer center 218 via cell tower 212b and cell carrier 210. The computer center 218 communicates with the monitoring station 222 via internet 220. Base station 10 can also communicate wirelessly with a variety of monitoring devices, including WIFI cameras 224a-b and home automation devices 226a-226c.

Secondary Protective Housing

The housing 11 of base station 10 is made from molded plastic or a similar material. While durable, the base station housing 11 is not typically adapted to withstand severe abuse, such as being shot with a gun, smashed with a baseball bat or hammer, or submerged in water. It is conceivable that a perpetrator could cause such severe abuse after triggering a sensor but before the base station 10 was able to initiate and compete a call to the remote monitoring stations and/or initiate and complete a communication (e.g., text message or alert) to a designated smart phone or other electronic device. It is also possible that a person could cause such abuse even prior to the base station 10 being armed. To address this contingency, the secondary protective housing 36 is configured to house the most critical electronic components and to be bullet proof, water proof and generally impermeable to essential any type of physical abuse that could be imposed on the portable base station in the context of the normal usage of the system.

The secondary protective housing 36 is made from an abuse-resistant and bullet proof material, such as polycarbonate, and it is configured to be waterproof. Super capacitor 112 is configured to store energy sufficient to power the microprocessor 120 and the transceiver cellular modem/GPS 118 for a short period of time. This described use of secondary protective housing 30 to protect the microprocessor 120 and the cellular modem/GPS 118 from essentially all types of abuse, along with the inclusion of super capacity 112, provides the base station 10 with the ability to communicate with the monitoring station 222 and/or a designated portable electronic device, e.g., 214a-214b for a short period of time after the base station 10 itself has been subjected to severe abuse or water damage. In this way, the microprocessor 120 is configured to receive status information from various components in the base station 10. When the microprocessor 120 identifies an abnormal condition within base station 10 that is indicative of abuse or water damage to the base station, the microprocessor initiates at least one wireless transmission to the monitoring station and/or designated portable electronic device with an alert of the condition. Secondary protective housing 36 ensures that the microprocessor 120 and cellular modem/GPS 120 stay functional even if the rest of the base station 10 has been compromised, and the super capacitor 112 ensures that the microprocessor 120 and cellular modem/GPS 118 have sufficient power for at least one final wireless transmission.

Surround Motion Sensing

The base station 10 includes a motion sensor 22 on the front of housing 11 and also a motion sensor 102 on the rear of the base station 10. Additionally, it may be desirable to include motion sensors on the sides of the base station 10. In this manner, the base station 10 is protected from attack from all directions and is able to trigger an alarm and wireless transmission in response to movement in any direction of the base station 10.

Integrated Hot Spot

The base station 10 and the wireless cameras 224a-224b connect to and communicate over the wi-fi network in the premises. The base station 10 then commonly transmits the captured video data to a remote electronic device, such as a smart phone or a computer.

Because video inherently comprises large amounts of data, using the wi-fi network of the monitored premises consumes large amounts of bandwidth on the network. Further, the wi-fi network of the premises is dependent upon receiving power from the power system of the premises being monitored. Accordingly, the wi-fi network is vulnerable to power outages. When the power to the monitored premises goes out, the wireless cameras are not able to communicate captured video to the base station 10 over the wi-fi network, and, as a result, the video data cannot be transmitted to the remote electronic device. Thus, the inventor has invented incorporating a 3G or 4G LTE or equivalent type wireless transceiver in the base station 10, which is configured to establish the base station 10 as a cellular hot spot that can only be accessed by the cameras (or other remote sensing devices) used in the portable alarm system. The wireless cameras would also include a 3G or 4G LTE transmitter. Because the base station 10 includes a rechargeable battery for powering the base station 10 during times of power outage or as simply an alternative source of power when stationary power is not readily available, the private 3G or 4G LTE is not entirely dependent on the stationary power of the monitored premises. Therefore, the 3G or 4G LTE private network can be used as an alternative mechanism for cameras to communicate captured video data to the base station 10. Once the video data is received by the base station 10, the base station 10 may transmit the video data to a remote electronic device in a manner typically used. In this way, a power outage in the premises does not affect the ability for the designated remote electronic device to receive the captured video data, so long as the battery in the base station 10 has sufficient charge.

Inter-Base Station Communications

Touch screen display 12 is configured to receive input and to display information. Currently, textual information relating to the portable alarm system can be displayed on the touch screen, such as information relating to triggering of one or more of the sensors, system status, textual communications from a monitoring station, etc. However, the inventor hereof has determined that it would be desirable and useful for a plurality of base stations 10 and 200a-200b to be able to communicate amongst themselves textual messages via a 3G or 4G LTE wireless network. Accordingly, a user of a first base station 10 could input (via the touchscreen or other input mechanism) a textual message, which could them be broadcast and transmitted to a plurality of other identified base stations. This mechanism would be useful in a variety of instances, including, for example, for communicating within a neighborhood information that is relevant to the neighborhood concerning safety, such as the identification of suspicious activity in the neighborhood. Further, this mechanism could be used to broadcast a message to a large group of users of base stations 10 and 200a-200b, such as in the context of a university or other defined community, such as the broadcast required under the Cleary Act in Florida requiring universities to broadcast campus-wide certain safety-related information.

On Demand Monitoring

Currently, alarm systems are generally configured to monitor a particular physical premise. The alarm system is generally monitored by a monitoring station 222. When the base station 10 recognizes that a sensor 230a-230d on the system has been triggered, the base station 10 sends a communication to the monitoring station 222, which typically takes certain actions in response thereto, such as sending a message to a remote electronic device (e.g., smart phone) and/or calling police or fire department for response to the premises, etc. The monitoring station typically charges a monthly fee to the user of the alarm system for the monitoring services. It is common for all sensors on the system to be given the same “priority,” i.e., if any sensor is triggered, a call is sent to the monitoring station.

The inventor hereof has invented a system that differentiates between sensors that communicate with the base station 10. The base station 10 discriminates and takes different actions depending on which of the sensors on the system are triggered. For example, an installed alarm system may be configured with outdoor motion sensors, window, door and glass breakage sensors, and indoor motion sensors. If an outdoor motion sensor is triggered, the base station may be configured to send a text alert directly to an electronic device (e.g., smart phone) without going through the monitoring station and/or to activate outdoor flood lights. If then a door, window or glass breakage sensor is triggered, the base station 10 may be configured to sound an audible alarm within the premises and to send an additional alert to the designated remote electronic device. If then an interior motion detector is triggered, the base station may be configured to communicate to the monitoring station, which, in turn, may communicate with a local police department and send out law enforcement to the premises. This tiered approach to configuring the responsive activities to take in response to different sensors being triggered improves accuracy of communications to the monitoring station and limits those communications to instances that are most likely to require law enforcement intervention.

As a result, the monitoring services may be billed in a more effective manner to the customer. For example, a monitoring service customer may be charged a fixed fee on a per call basis, as opposed to a flat rate monthly fee. This approach is likely to be more desirable for customers who only require outside monitoring for those situations that are likely to be most dire and that require intervention of law enforcement.

Dual Communication Sensors

The wireless sensors that are used with the alarm system commonly are “one directional” in the sense that they, when triggered, communicate a wireless alarm signal back to the base station 10, which acts upon the signal in a particular manner, e.g., sound audible alarm, call monitoring station, etc. The inventor has invented wireless sensors that include dual “two way” communication with the base station 10. Specifically, in addition to communicating the traditional alarm signal from the sensor to the base station 10, the dual communication sensors are configured to receive data from the base station 10 as well. This dual communication capability enables the sensors to receive audible data, for example. This capability can be useful for a user of the alarm system to be able to communicate to persons through the sensor. For example, if a perpetrator triggers an outdoor motion sensor, the base station 10 may communicate to the sensor to provide an audible alert and/or audible voice communication, such as “Trespasser—Please leave premises.” The particular audible information to communicate can be adjusted, and, the base station 10 may receive the audible information in real time from an occupant of the premises, who speaks the information into the base station 10. In any event, the base station communicates to the sensor, which converts the audible data to an audible sound and projects it through a built-in speaker in the sensor. Other uses for the two-way dual communication between the base station 10 and the sensors are possible.

Voice Recognition

The inventor hereof has invented a base station 10 and/or remote wireless sensors that are capable to detecting audible voice triggers. That is, a base station 10 and/or remote sensors 230a-230d can be equipped with microphones configured to receive audible information, to convert such audible information to digital data and to assess the digital data to determine if the audible information matches a particular profile that would be sufficient to trigger an alarm. For example, the base station 10 and/or sensors could be configured to recognize certain words, such as “Help”, or “Get Out”, etc., particularly when spoken in high pitches, loud volumes, in repeated fashion or certain combinations. When such audible triggers are detected and deciphered, the base station 10 can treat it an alarm trigger and take action in any number of configured ways, e.g., sound audible alarm, call monitoring station, etc.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A portable alarm system, comprising:
a portable base station, including an outer housing that encloses a power supply and a watertight secondary protective housing;
a controller enclosed in the watertight secondary protective housing;
a cellular modem enclosed in the watertight secondary protective housing that is electrically connected to the controller; and
a super capacitor enclosed in the watertight secondary protective housing that is configured to maintain a store of energy and that is electrically connected to the controller and the cellular modem to provide power thereto.

2. A portable alarm system, comprising:
a portable base station, including an outer housing that encloses a processor, a power supply, and a communication interface configured to wirelessly communicate with a plurality of remote sensors;
at least first and second remote sensors configured to wirelessly communicate to the communication interface of the portable base station,
wherein the first remote sensor has a first identifier and the second remote sensor has a second identifier that is different from the first identifier; and
said processor is configured to cause data to be transmitted to a monitoring station in response to receiving a communication from the first remote sensor and to cause data to be transmitted to a portable remote electronic device in response to receiving a communication from the second remote sensor.
